(19) United States
(12) Patent Application Publication
(10) Pub. No.: US 2012/0049047 A1
(43) Pub. Date: Mar. 1, 2012

(54) Sensing Devices

(75) Inventors: Ping-Hung Yin, Grand Cayman (KY); Van Brian, Grand Cayman (KY)

(73) Assignee: HIMAX IMAGING, INC., Grand Cayman (KY)

(21) Appl. No.: 12/873,494

(22) Filed: Sep. 1, 2010

(51) Int. Cl. G01J 1/42

(52) U.S. Cl. 250/208.2

(57) ABSTRACT

A sensing device includes a pixel unit and an output unit. The pixel unit includes a sensing element, a transfer transistor, a reset transistor, and an output transistor. The transfer transistor is coupled between the sensing element and a floating diffusion node. The reset transistor is coupled between a first node and the floating diffusion node. The output transistor has a control terminal coupled to the floating diffusion node and an input terminal coupled to the first node. During a readout period, the reset transistor is controlled by a reset phase to reset a level of the floating diffusion node. The output unit generates a pixel output signal at the first node according to the level of the floating diffusion node and a reference signal. During the readout period, the reference signal is at a higher level, and after the reset phase, the reference signal is at a lower level.

### BACKGROUND OF THE INVENTION

1. Field of the Invention

The invention relates to a sensing device, and more particularly, to a sensing device with a pixel amplifier having a two-step reference voltage.

2. Description of the Related Art

Generally, a sensing pixel comprises a sensing element, a transfer transistor, a reset transistor, and a source follower transistor. The transfer transistor, the reset transistor, and the source follower transistor are coupled to a floating diffusion node which is coupled to the control terminal of the source flower transistor. The sensing element senses light to generate a sensing signal in an exposure period, and the transfer transistor is turned on to transfer the sensing signal to the floating diffusion node in a readout period for readout operations. During the readout period, before the transfer transistor transfers the sensing signal to the floating diffusion node, the reset transistor is turned on to reset the level of the floating diffusion node to a predetermined level which serves as a base level for the transferred sensing signal. However, when the reset transistor is turned off when the reset operation is accomplished, the level of the floating diffusion node drops from the predetermined level due to the current injection effect caused by the reset transistor. This drop in the level of the floating diffusion node results in less pixel output swing, which is unfavorable for readout operations.

Thus, it is desired to provide a sensing device which can solve current injection effect caused by the reset transistor in a pixel unit.

### BRIEF SUMMARY OF THE INVENTION

An exemplary embodiment of a sensing device comprises a pixel unit and an output unit. The pixel unit operates during an exposure period and during a readout period. The pixel unit comprises a sensing element, a transfer transistor, a reset transistor, and a transistor. The sensing element is used to sense light. The transfer transistor is coupled between the sensing element and a floating diffusion node. The reset transistor is coupled between a first node and the floating diffusion node and controlled by a reset signal. The output transistor has a control terminal coupled to the floating diffusion node, an input terminal coupled to the first node, and an output terminal. During the readout period, the reset transistor is controlled by a reset phase of the reset signal to reset a level of the floating diffusion node. The output unit is coupled to the output transistor. The output unit receives a reference signal and generates a pixel output signal at the first node according to the level of the floating diffusion node and the reference signal. During the readout period, the reference signal is at a first level, and after the reset phase, the reference signal is at a second level which is lower than the first level.

Another exemplary embodiment of a sensing device comprises a pixel unit. The pixel unit operates during an exposure period and during a readout period and comprises a sensing element, a reset transistor, and an output transistor. The sensing element is used to sense light. The reset transistor is coupled between a voltage source and a floating diffusion node and controlled by a reset signal. The output transistor has a control terminal coupled to the floating diffusion node, an input terminal coupled to the voltage source, and an output terminal. During the readout period, the reset transistor is controlled by a reset phase of the reset signal to reset a level of the floating diffusion node. During the readout period, the voltage source is at a first level, and after the reset phase, the voltage source is at a second level which is lower than the first level.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows an exemplary embodiment of a sensing device;

FIG. 2 shows a timing diagram of key signals in the sensing device in FIG. 1 during the readout period;

FIG. 3 shows the pixel unit with an exemplary embodiment of the output unit 11 in FIG. 1.

FIG. 4 shows the pixel unit with another exemplary embodiment of the output unit 11 in FIG. 1;

FIG. 5 shows a timing diagram of key signals in the sensing device in FIG. 4 during the readout period;

FIG. 6 shows another exemplary embodiment of a sensing device; and

FIG. 7 shows a timing diagram of key signals in the sensing device in FIG. 6 during the readout period

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

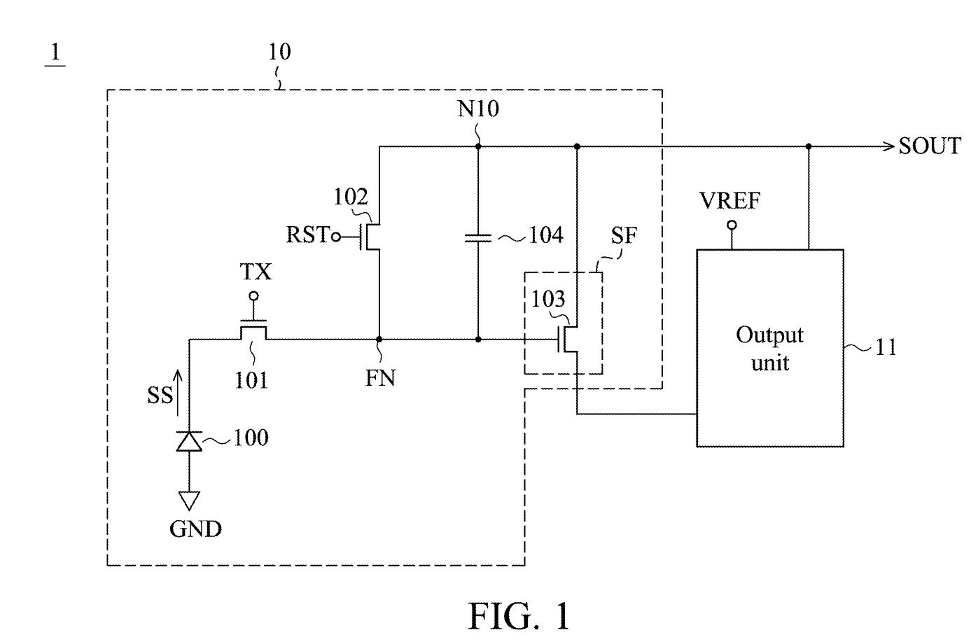

Sensing devices are provided. In an exemplary embodiment of a sensing device in FIG. 1, a sensing device 1 comprises a pixel unit 10 and an output unit 11. The pixel unit 10 comprises a sensing element 100, a transfer transistor 101, a reset transistor 102, and a source follower SF. The source follower SF comprises an output transistor 103, and an input terminal of the source follower SF is coupled to the control terminal of the output transistor 103. The transistors 101-103 are NMOS transistors. The pixel unit 10 operates during an exposure period and during a readout period. Referring to FIG. 1, the sensing element 100 is implemented by a photo diode having an anode electrode coupled to a ground GND and a cathode electrode. A control terminal of the transfer transistor 101 receives a control signal TX, an input terminal thereof is coupled to the cathode electrode of the photo diode 100, and an output terminal thereof is coupled to a floating diffusion node FN. A control terminal of the reset transistor 102 receives a reset signal RST, an input terminal thereof is coupled to a node N10, and an output terminal thereof is coupled to the floating diffusion node NF. A control terminal of the output transistor 103 is coupled to the floating diffusion node NF, an input terminal thereof is coupled to the node N10, and an output terminal coupled to the output unit 11. The pixel unit 10 further comprises a capacitor 104 coupled between the node N10 and the floating diffusion node NF. The capacitor 104 is a substantial capacitor or a parasitical capacitor of the output transistor 103.

The output unit 11 is coupled to the output terminal of the transistor 103. The output unit 11 receives a reference signal VREF and generates a pixel output signal SOUT at the node N10 according to the level of the floating diffusion node FN and the reference signal VREF. In the embodiment, the reference signal VREF is a two-step voltage signal.

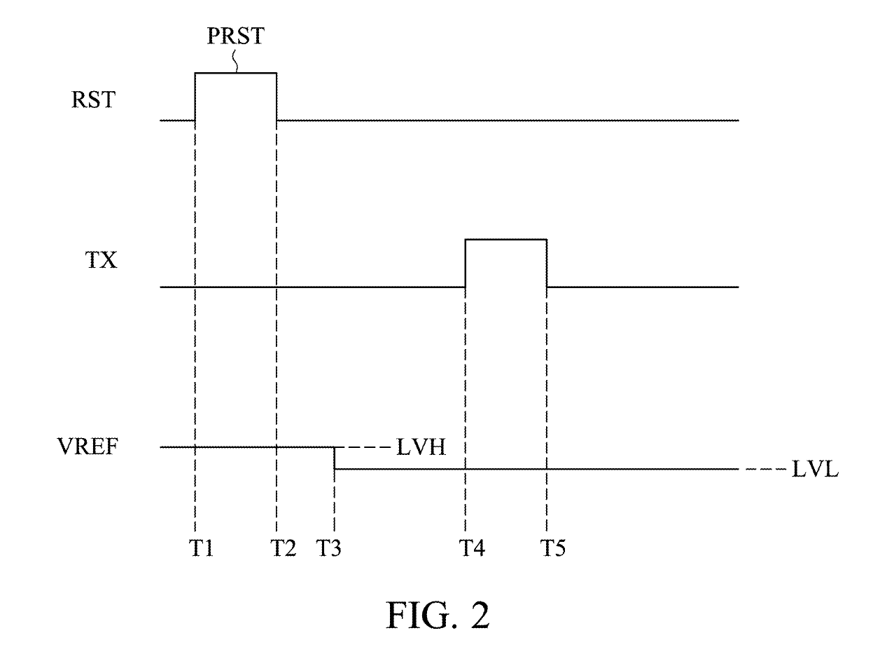

During the exposure period, the sensing element 100 senses light to generate a sensing signal SS. FIG. 2 shows a timing diagram of key signals in the sensing device 1 during the readout period following the exposure period. Referring to FIGS. 1 and 2, during the readout period, the reset signal RST is asserted between a time point T1 and a time point T2, which occurs after the time point T1, to form a reset phase PRST. The reset transistor 102 is turned on by the reset phase PRST to reset the level of the floating diffusion node FN. The reference signal VREF is at a higher level LVH between the time point T1 and a time point T3, which occurs after the time point T2, and then is switched to be at a lower level LVL at the time point T3. In other words, the reference signal VREF is switched to be at the lower level LVL after the reset phase PRST. Then, at a time point T4 after the time point T3, the control signal TX is asserted to turn on the transfer transistor 101 to transfer the sensing signal SS to the floating diffusion node FN.

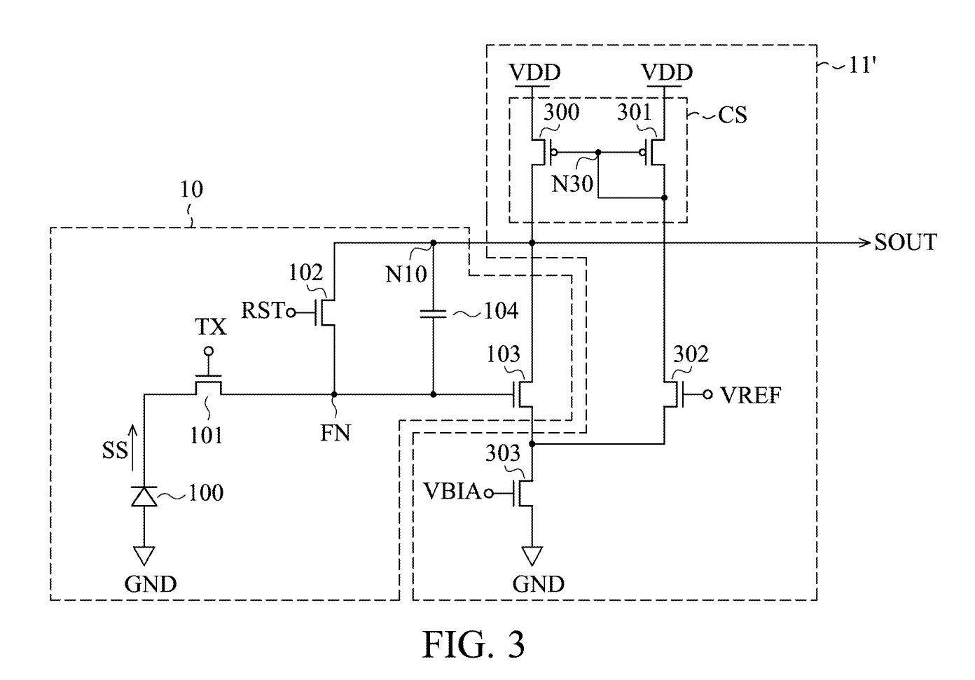

FIG. 3 shows the pixel unit 10 with an exemplary embodiment of the output unit 11 in FIG. 1. Referring to FIG. 3, the output unit 11′ comprises transistors 300-303, wherein the transistors 300 and 301 are PMOS transistors, and the transistors 302 and 303 are NMOS transistors. A control terminal of the transistor 300 is coupled to a node N30, an input terminal thereof is coupled to a supplying voltage source VDD, and an output terminal thereof is coupled to the node N10. A control terminal of the transistor 301 is coupled to the node N30, an input terminal thereof is coupled to the supplying voltage source, and an output terminal thereof is coupled to the control terminal of the transistor 301 at the node N30. The transistors 300 and 301 form a current source CS. A control terminal of the transistor 302 directly receives the reference signal VREF, an input terminal thereof is coupled to the output terminal of the transistor 301 at the node N30, and an output terminal thereof is coupled to the output terminal of the output transistor 103. A control terminal of the transistor 303 receives a bias voltage VBIA, an input terminal thereof is coupled to the output terminal of the output transistor 103, and an output terminal thereof is coupled to the ground GND.

Referring to FIG. 3, the output transistor 103 and the transistors 300-303 of the output unit 30 form a differential amplifier. The capacitor 104 serves as a feedback capacitor of the differential amplifier. The differential amplifier generates the pixel output signal SOUT at the node N10 according to the difference between the level of the floating diffusion node FN and the reference signal VREF. During the readout period, the pixel output signal SOUT is sampled twice for correlated double sampling (CDS) of readout operations. In detail, the pixel output signal SOUT is sampled to generate a base value before the control signal TX is asserted (that is before the time point T4) and then sampled to generate an output value after the control signal TX is de-asserted (that is after the time point T5). The difference between the base value and the output value serves as a readout signal which represents the intensity of the sensed light by the photo diode 100.

In FIG. 2, the reference signal VREF is at the higher level LVH, and at the time point T3 after the reset phase PRST, the reference signal VREF is switched to be at the lower level LVL. When the reset transistor 102 is turned off at the time point T2, the level of the floating diffusion node FN drops due to the current injection effect caused by the reset transistor 102. Assume that the reference signal VREF is continuously at the higher level LVH. Before the time point T4, the differential amplifier generates a pixel output signal SOUT with a higher level according to the dropped level of the floating diffusion node FN and the reference signal VREF with the higher level LVH. In other words, the base value obtained by sampling the pixel output signal SOUT before the time point T4 is large. Thus, the swing of the readout signal generated according to the difference between the base value and the output value is less, which is unfavorable for subsequent readout operations.

However, in the embodiment, the reference signal VREF is not always at the higher level LVH. When the reset transistor 102 is turned off at the time point T2, the level of the floating diffusion node FN drops due to the current injection effect caused by the reset transistor 102. Moreover, at the time point T3, the reference signal VREF drops to the lower level LVL. Thus, before the time point T4, the differential amplifier generates a pixel output signal SOUT according to the dropped level of the floating diffusion node FN and the reference signal VREF with the lower level LVL, and the level of the pixel output signal SOUT is lower than the level of the pixel output signal SOUT when the reference signal VREF is continuously at the higher level LVH. Thus, the base value, which is obtained by sampling the pixel output signal SOUT before the time point T4, does not become larger with the dropped level of the floating diffusion node FN. Accordingly, the swing of the readout signal generated by the difference between the base value and the output value is moderate.

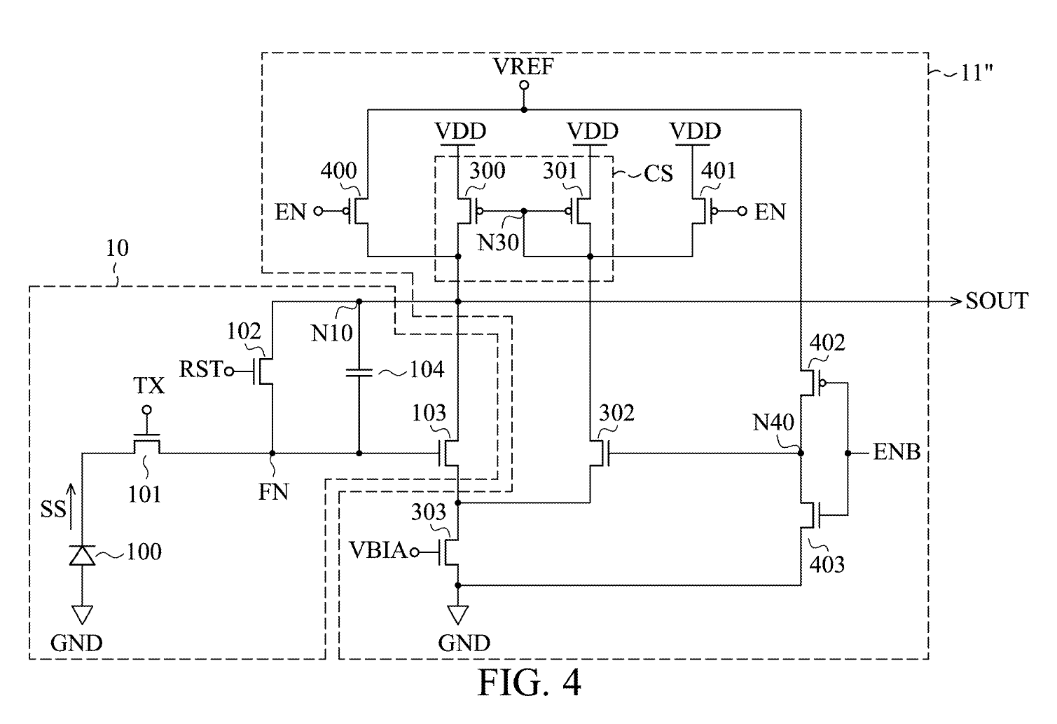

FIG. 4 shows the pixel unit 10 with another exemplary embodiment of the output unit 11 in FIG. 1. The output unit 11″ comprises the transistors 300-303 in FIG. 3. Except for the connection of the control terminal of the transistor 302 in FIG. 4, the connection between the transistors 300-303 in FIG. 4 is same as the connection in FIG. 3. Thus, the connection between the transistors 300-303 is omitted here for brevity. The output unit 11″ further comprises transistors 400-403, wherein the transistors 400-402 are PMOS transistors, while the transistor 403 is an NMOS transistor. A control terminal of the transistor 400 receives an enable signal EN, an input terminal thereof receives the reference signal VREF, and an output terminal thereof is coupled to the node N10. A control terminal of the transistor 401 receives the enable signal EN, an input terminal thereof is coupled to the supplying voltage source, and an output terminal thereof is coupled to the node N30. A control terminal of the transistor 402 receives an enable signal ENB, an input terminal thereof receives the reference signal VREF, and an output terminal thereof is coupled to a node N40. The enable signal ENB is inverse to the enable signal EN. A control terminal of the transistor 403 receives the enable signal ENB, an input terminal thereof is coupled to the node N40, and an output terminal thereof is coupled to the ground. Since the transistors 402 and 403 are a PMOS transistor and an NMOS transistor, respectively and both receive the enable signal ENB, the transistors 402 and 403 are turned on by the enable signal ENB at different time. According to FIG. 4, the control terminal of the transistor 302 does not directly receive the reference signal VREF as the control terminal of the transistor 302 in FIG. 3. The reference signal VREF is provided to the transistor 402, and the control terminal of the transistor 302 receives the reference signal VREF through the transistor 402, which was turned on by the enable signal ENB.

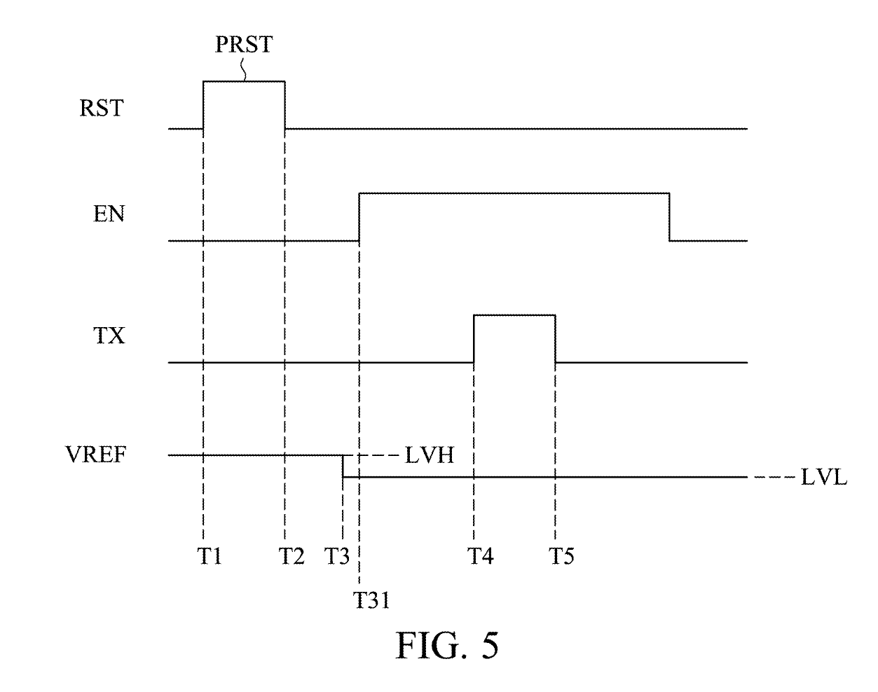

FIG. 5 shows a timing diagram of key signals in the sensing device in FIG. 4 during the readout period. The timing of the reset signal RST, the control signal TX, and the reference signal VREF in FIG. 5 is the same as the timing in FIG. 2. Thus, the operations of the pixel unit 10 according to the reset signal RST and the control signal TX are the same as the description related to FIG. 3. FIG. 5 additionally shows the timing of the enable signal EN controlling the transistors 400 and 401. Before a time point T31 between the time points T3 and T4, the enable signal EN is de-asserted to turn on the transistors 400 and 401, and, accordingly, the enable signal ENB is asserted to turn off the transistor 402 and turn on the transistor 403. At the time point T31, the enable signal EN is asserted to turn off the transistors 400 and 401, and, accordingly, the enable signal ENB is de-asserted to turn on the transistor 402 and turn off the transistor 403.

Referring to FIG. 4, the output transistor 103 and the transistors 300-303 and 400-402 of the output unit 11″ form a differential amplifier. The differential amplifier generates the pixel output signal SOUT at the node N10 according to the difference between the level of the floating diffusion node FN and the reference signal VREF. During the readout period, the pixel output signal SOUT is sampled twice for correlated double sampling (CDS) of readout operations. In detail, referring to FIG. 5, the pixel output signal SOUT is sampled to generate a base value before the control signal TX is asserted (that is before the time point T4) and then sampled to generate an output value after the control signal TX is de-asserted (that is after the time point T5). The difference between the base value and the output value serves as a readout signal which represents the intensity of the sensed light by the photo diode 100.

According to the embodiment of FIG. 5, the reference signal VREF is a two-step voltage signal. The reference signal VREF is at the higher level LVH between the time point T1 and the time point T3, and then is switched to be at the lower level LVL at the time point T3.

Referring to FIGS. 4 and 5, before the time point T3, the enable signal EN is de-asserted to turn on the transistors 400 and 401. The voltage of the node N10 is at the higher level LVH according to the reference signal VREF with the higher level LVH, when transmitted through the turned-on transistor 400. Moreover, the reset signal RST is asserted between the time point T1 and the time point T2 to form the reset phase PRST. The reset transistor 102 is turned on by the reset phase PRST to reset the level of the floating diffusion node FN by the reference signal VREF with the higher level LVH. At the time point T3 after the reset phase PRST, the reference signal VREF is switched to be at the lower level LVL. At the time point T31, the enable signal EN is asserted to turn off the transistors 400 and 401, and, accordingly, the enable signal ENB is de-asserted to turn on the transistor 402 and turn off the transistor 403. Thus, the voltage of the node N40 is at the lower level LVL. In other words, the node N40 (the control terminal of the transistor 302) receives the reference signal VREF with the lower level LVL through the turned-on transistor 402. Then, at the time point T4 after the time point T3, the control signal TX is asserted to turn on the transfer transistor 101 to transfer the sensing signal SS to the floating diffusion node FN.

When the reset transistor 102 is turned off at the time point T2, the level of the floating diffusion node FN drops from the higher level LVH due to the current injection effect caused by the reset transistor 102. Assume that the reference signal VREF is continuously at the higher level LVH. Before the time point T4, the differential amplifier generates a pixel output signal SOUT with a higher level according to the dropped level of the floating diffusion node FN and the reference signal VREF. In other words, the base value obtained by sampling the pixel output signal SOUT before the time point T4 is large. Thus, the swing of the readout signal generated by the difference between the base value and the output value is less, which is unfavorable for subsequent readout operations.

However, in the embodiment, the reference signal VREF is not always at the higher level LVH. When the reset transistor 102 is turned off at the time point T2, the level of the floating diffusion node FN drops from the higher level LVH due to the current injection effect caused by the reset transistor 102. Moreover, at the time point T3, the voltage reference VREF drops to the lower level LVL, and, accordingly, the voltage of the node N40 (the control terminal of the transistor 302) receives the reference signal VREF with the lower level LVL through the turned-on transistor 402. Thus, before the time point T4, the differential amplifier generates a pixel output signal SOUT according to the dropped level of the floating diffusion node FN and the lower level LVL of the node N40, and the level of the pixel output signal SOUT is lower than the level of the pixel output signal SOUT when the reference signal VREF is continuously at the higher level LVH. Thus, the base value, which is obtained by sampling the pixel output signal SOUT before the time point T4, does not become larger with the dropped level of the floating diffusion node FN. Accordingly, the swing of the readout signal generated by the difference between the base value and the output value is moderate.

According to the above embodiments, the output unit 11/11′/11″ and the output transistor 103 form a differential amplifier. One input terminal of the differential amplifier is coupled to the floating diffusion node FN. The other input terminal of the differential amplifier directly receives the reference signal VREF as the embodiment of FIG. 3 or receives the reference signal VREF with the lower level LVL through the turned-on transistor 402 as the embodiment of FIG. 4. When the reset transistor 102 is turned off, the level of the floating diffusion node FN drops from the higher level LVH due to the current injection effect, and, further, the voltage reference VREF drops to the lower level LVL. Thus, the level of the pixel output signal SOUT does not become higher with the dropped level of the floating diffusion node FN, and the base value of the CDS operation is not larger. Accordingly, the swing of the readout signal generated by the difference between the base value and the output value is moderate.

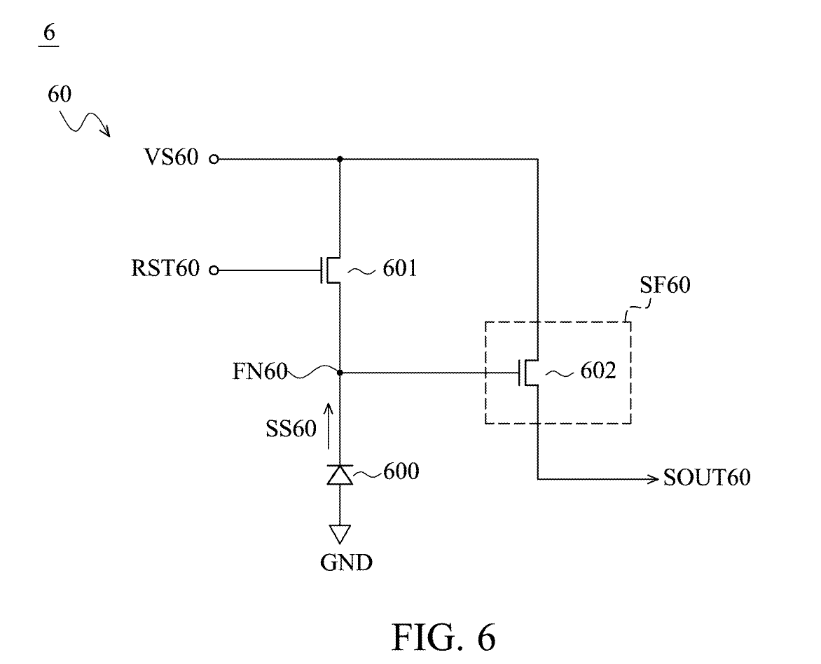

In another exemplary embodiment of a sensing device in FIG. 6, a sensing device 6 comprises a pixel unit 60. The pixel unit 60 comprises a sensing element 600, a reset transistor 601, and a source follower SF60. The source follower SF60 comprises an output transistor 602, and an input terminal of the source follower SF60 is coupled to the control terminal of the output transistor 602. The pixel unit 60 operates during an exposure period and during a readout period. Referring to FIG. 6, the sensing element 600 is implemented by a photo diode having an anode electrode coupled to a ground GND and a cathode electrode coupled to a floating diffusion node FN60. A control terminal of the reset transistor 601 receives a reset signal RST60, an input terminal thereof is coupled to a voltage source VS60, and an output terminal thereof is coupled to the floating diffusion node FN60. A control terminal of the output transistor 602 is coupled to the diffusion node FN60, and an input terminal thereof is coupled to the voltage source VS60. A pixel output signal SOUT60 is generated at the output terminal of the output transistor 602 according to the level of the floating diffusion node FN60 and the voltage source VS60.

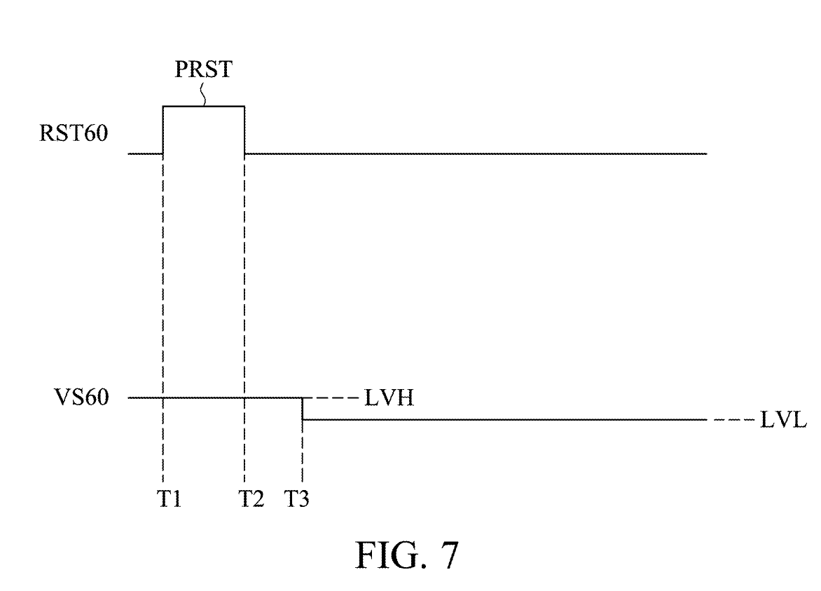

During the exposure period, the sensing element 600 senses light to generate a sensing signal SS60. FIG. 7 shows a timing diagram of key signals in the sensing device 6 during the readout period following the exposure period. Referring to FIGS. 6 and 7, during the readout period, the reset signal RST60 is asserted between a time point T1 and a time point T2, which occurs after the time point T1, to form a reset phase PRST. The reset transistor 601 is turned on by the reset phase PRST to reset the level of the floating diffusion node FN60. The voltage source VS60 VREF is at a higher level LVH between the time point T1 and a time point T3, which occurs after the time point T2, and then is switched to be at a lower level LVL at the time point T3. In other words, the voltage source VS60 is switched to be at the lower level LVL after the reset phase PRST.

During the readout period, the pixel output signal SOUT60 is sampled twice for correlated double sampling (CDS) of readout operations. In detail, the pixel output signal SOUT60 is sampled to generate a base value between the time points T2 and T3 and then sampled to generate an output value after the time point T3. The difference between the base value and the output value serves as a readout signal which represents the intensity of the sensed light by the photo diode 600. According to the embodiment of FIG. 6, the pixel output signal SOUT60 is determined according to the level of the floating diffusion node FN60 and the voltage source VS60. The voltage source VS60 is not always at the higher level LVH. At the time point T3, the voltage source VS60 is switched from the higher level LVH to the lower voltage LVL. Thus, the readout signal which is generated according to the difference between the base value before the time point T3 and the output value after the time point T3 becomes large.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A sensing device comprising:
a pixel unit operating during an exposure period and during a readout period, comprising:
a sensing element for sensing light;
a transfer transistor coupled between the sensing element and a floating diffusion node;
a reset transistor coupled between a first node and the floating diffusion node and controlled by a reset signal; and
an output transistor having a control terminal coupled to the floating diffusion node, an input terminal coupled to the first node, and an output terminal;
wherein, during the readout period, the reset transistor is controlled by a reset phase of the reset signal to reset a level of the floating diffusion node; and
an output unit, coupled to the output transistor, for receiving a reference signal and generating a pixel output signal at the first node according to the level of the floating diffusion node and the reference signal;
wherein, during the readout period, the reference signal is at a first level, and after the reset phase, the reference signal is at a second level which is lower than the first level.

2. The sensing device as claimed in claim 1, wherein during the readout period, the reset signal is asserted between a first time point and a second time point, which occurs after the first time point, to form the reset phase, and the reference signal is at the first level between the first time point and a third time point, which occurs after the second time point, and is switched to be at the second level at the third time point.

3. The sensing device as claimed in claim 2, wherein the sensing element senses light to generate a sensing signal during the exposure period, and the transfer transistor transfers the sensing signal to the floating diffusion node at a fourth time point which occurs after the third time point during the readout period.

4. The sensing device as claimed in claim 1, wherein the output unit comprises:
a first transistor having a control terminal coupled to a second node, an input terminal coupled to a supplying voltage source, and an output terminal coupled to the first node;
a second transistor having a control terminal coupled to the second node, an input terminal coupled to the supplying voltage source, and an output terminal coupled to the second node; and
a third transistor having a control terminal receiving the reference signal, an input terminal coupled to the second node, and an output terminal coupled to the output terminal of the output transistor.

5. The sensing device as claimed in claim 4, wherein the output transistor, the first transistor, the second transistor, and the third transistor form an amplifier which generates the pixel output signal according to the difference between the level of the floating diffusion node and the reference signal.

6. The sensing device as claimed in claim 5, wherein the pixel unit further comprises a capacitor coupled between the first node and the floating diffusion node and serving as a feedback capacitor of the amplifier.

7. The sensing device as claimed in claim 6, wherein the capacitor is a substantial capacitor or a parasitical capacitor of the output transistor.

8. The sensing device as claimed in claim 1, wherein the output unit comprises:
a first transistor having a control terminal coupled to a second node, an input terminal coupled to a supplying voltage source, and an output terminal coupled to the first node;
a second transistor having a control terminal coupled to the second node, an input terminal coupled to the supplying voltage source, and an output terminal coupled to the second node;
a third transistor having a control terminal receiving a first enable signal, an input terminal receiving the reference signal, and an output terminal coupled to the first node;
a fourth transistor having a control terminal receiving the first enable signal, an input terminal coupled to the supplying voltage source, and an output terminal coupled to the second node;
a fifth transistor having a control terminal receiving a second enable signal, an input terminal receiving the reference signal, and an output terminal coupled to a third node, wherein the second enable signal is inverse to the first enable signal;
a sixth transistor having a control terminal receiving the second enable signal, an input terminal coupled to the third node, and an output terminal coupled to a ground, wherein the fifth transistor and the sixth transistor are turned on at different time; and
a seventh transistor having a control terminal coupled to the third node, an input terminal coupled to the second node, and an output terminal coupled to the output terminal of the output transistor.

9. The sensing device as claimed in claim 8, wherein the output transistor and the output unit form an amplifier which generates the pixel output signal according to the difference between the level of the floating diffusion node and the reference signal.

10. The sensing device as claimed in claim 9, wherein the pixel unit further comprises a capacitor coupled between the first node and the floating diffusion node and serving as a feedback capacitor of the amplifier.

11. The sensing device as claimed in claim 10, wherein the capacitor is a substantial capacitor or a parasitical capacitor of the output transistor.

12. The sensing device as claimed in claim 8, wherein during the readout period, the reset signal is asserted between a first time point and a second time point, which occurs after the first time point, to form the reset phase, and the reference signal is at the first level between the first time point and a third time point, which occurs after the second time point, and is switched to be at the second level at the third time point.

13. The sensing device as claimed in claim 12, wherein the sensing element senses light to generate a sensing signal during the exposure period, and the transfer transistor transfers the sensing signal to the floating diffusion node at a fourth time point which occurs after the third time point during the readout period.

14. The sensing device as claimed in claim 12, wherein after the third time point and before the transfer transistor transfers the sensing signal to the floating diffusion node, the first enable signal is asserted to turn off the third transistor and the fourth transistor, and the second enable signal is de-asserted to turn on the fifth transistor and off the sixth transistor.

15. A sensing device comprising:
a pixel unit operating during an exposure period and during a readout period, comprising:
a sensing element for sensing light;
a reset transistor coupled between a voltage source and a floating diffusion node and controlled by a reset signal; and
an output transistor having a control terminal coupled to the floating diffusion node, an input terminal coupled to the voltage source, and an output terminal;
wherein, during the readout period, the reset transistor is controlled by a reset phase of the reset signal to reset a level of the floating diffusion node;
wherein, during the readout period, the voltage source is at a first level, and after the reset phase, the voltage source is at a second level which is lower than the first level.

16. The sensing device as claimed in claim 15, wherein during the readout period, the reset signal is asserted between a first time point and a second time point, which occurs after the first time point, to form the reset phase, and the voltage source is at the first level between the first time point and a third time point, which occurs after the second time point, and is switched to be at the second level at the third time point.
